(19) United States
(12) Patent Application Publication
(10) Pub. No.: US 2007/0039492 A1
(43) Pub. Date: Feb. 22, 2007

(54) Method and apparatus for operating a printing-press system

(75) Inventors: Hubert Ahle, Augsburg (DE); Klaus Theilacker, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/482,488

(22) Filed: Jul. 7, 2006

(30) Foreign Application Priority Data
Jul. 9, 2005 (DE) 10 2005 032 188.7

(51) Int. Cl. B41M 1/14

(52) U.S. Cl. 101/211

(57) ABSTRACT

A method and apparatus for operating a printing-press system is disclosed, in which at least one paper web is guided, printed and folded by functional units of the printing press on at least one web path for a printing process. The functional units having at least one paper-inserting mechanism, at least one reel changer, at least one printing unit, and at least one folder apparatus. The functional units which belong to a web path are actuated jointly and different functional units of different web paths are controlled individually.

This application claims the priority of German Patent Document No. 10 2005 032 188.7, filed Jul. 9, 2005, the disclosure of which is expressly incorporated by reference herein.

### BACKGROUND AND SUMMARY OF THE INVENTION

The invention relates to a method and apparatus for operating a printing-press system.

Different production runs are produced constantly with printing presses, above all newspaper presses. Here, every production run, for example a newspaper print run, requires different paths from a reel changer via one or more printing units to a folding former. This instantaneous production-specific path is defined as the web path in the control apparatus of the printing-press system.

If a plurality of web paths are required for the production run, the paper webs have previously been inserted on these web paths one after another from the reel changers to the inlet of the folding former; this is then called what is known as an individual insertion. As this led to long changeover times as a function of the number of web paths and the different length of the web paths, this approach has been dropped.

A further possibility of supplying paper consisted in inserting approximately two to four paper webs at the same time; this is then called what is known as multiple insertion. Here, possible different web lengths of the different paper webs on the different web paths were compensated for by the insertion apparatuses after the reel changers starting up the insertion of paper at different times and then transporting the paper webs at the same speed to the inlet of the folding former. It proved disadvantageous in this method of paper supply that the paper-inserting tips which lie one above another and have a material thickness of a few millimeters led partly to the paper webs tearing or to a paper jam in the inlet of the folding former.

It is therefore an object of the invention to shorten the changeover time for a printing press, above all during the insertion of paper, to minimize waste products and at the same time to optimize the utilization and the production efficiency of the printing-press system.

Proceeding from this, the present invention is based on the object of changing the controller of a printing-press system in such a way that different web paths act differently from one another. This object is achieved by a method and apparatus for operating a printing-press system.

The functional units which belong to a web path are actuated jointly and different functional units of different web paths are controlled individually by the method and apparatus according to the invention for operating a printing-press system, in which at least one paper web is guided, printed and folded by functional units of the printing press on at least one web path for a printing process, the functional units having at least one paper-inserting means, at least one reel changer, at least one printing unit and at least one folder apparatus.

It is therefore possible by way of this novel method and apparatus for a plurality of functions to be executed simultaneously or offset temporally as desired, for example during the process of inserting the paper, which functions use a plurality of functional elements of the printing press. This simultaneous or offset execution permits a plurality of work steps, such as the supplying of the printing press or the actual printing process, to be executed in parallel alongside one another. As a result, the supply time can be shortened, above all during the insertion of paper, paper waste can be minimized and the utilization and the production efficiency of a printing-press system can be optimized.

For example, while one paper web is being inserted with one paper-insertion apparatus at a defined speed from one reel changer to the folding former, another paper insertion operation of a second or third paper web can be prepared by way of the novel method and apparatus.

In this way, it is also possible for different work operations of the printing-press system to be executed in parallel alongside one another, either simultaneously or offset temporally, in the different web paths, such as the insertion of paper.

Preferred developments of the invention result from the following description.

In one advantageous embodiment of the invention, the functional units of different web paths can be operated at different speeds. Therefore, on a printing-press system, the paper can be inserted automatically with the paper-inserting apparatus at approximately 50 meters/minute from the second reel changer to the turner stage, and the turned part web of the first reel changer can be inserted manually at a speed of approximately 5 meters/minute which is lower for safety reasons from the turner stage to the former.

It is advantageous if the functional units of different web paths are operated in different rotational directions.

The functional units of different web paths can be started at different times. As a result, different working or operating states of the printing press can be treated in a manner which is separated temporally from one another, or can be executed in a manner which is separate from one another. This therefore makes a more individual use of the printing press possible, compared with the printing presses which have previously usually run at the same speed, for example the synchronous running of the synchronized printing units or their cylinders.

As an alternative or in addition to the individual starting of the different functional units, the novel method and apparatus makes it possible for the functional units of different web paths to stop at different times. As a result, for example, a paper web can be inserted as far as the folding former, while the other paper webs have already been stopped before or after the turner stage or turner stages. The abovementioned paper jam or web tear in the region of the inlet of the folding former can be avoided as a result.

One favorable variant of the novel method and apparatus provides for the drives which belong to a specific web path to be actuated jointly. The synchronization of the drive motors and a uniform speed of the paper web on this web path are ensured more simply as a result.

Each printing unit of an offset printing press has at least one plate cylinder and one blanket cylinder. As a result of the novel method and apparatus, the cleaning processes in the different printing units can be started and stopped individually, independently of the insertion of paper via the other printing units of the same printing system.

### BRIEF DESCRIPTION OF THE DRAWINGS

Exemplary embodiments of the invention will be explained in greater detail using the drawings, without being restricted thereto. In the drawings:

FIG. 1 shows a diagrammatic illustration of the individual insertion of six paper webs in a newspaper press;

FIG. 2 shows a diagrammatic illustration of the simultaneous insertion of paper webs (multiple insertion) in a newspaper press;

FIG. 3 shows a diagrammatic illustration of the method and apparatus according to the invention during the insertion of paper webs (magazine insertion) in a newspaper press;

FIG. 4 shows a diagram of the insertion waste of the individual-web insertion and magazine insertion; and

FIG. 5 shows a diagram of the insertion time of the individual-web insertion and magazine insertion.

### DETAILED DESCRIPTION OF THE DRAWINGS

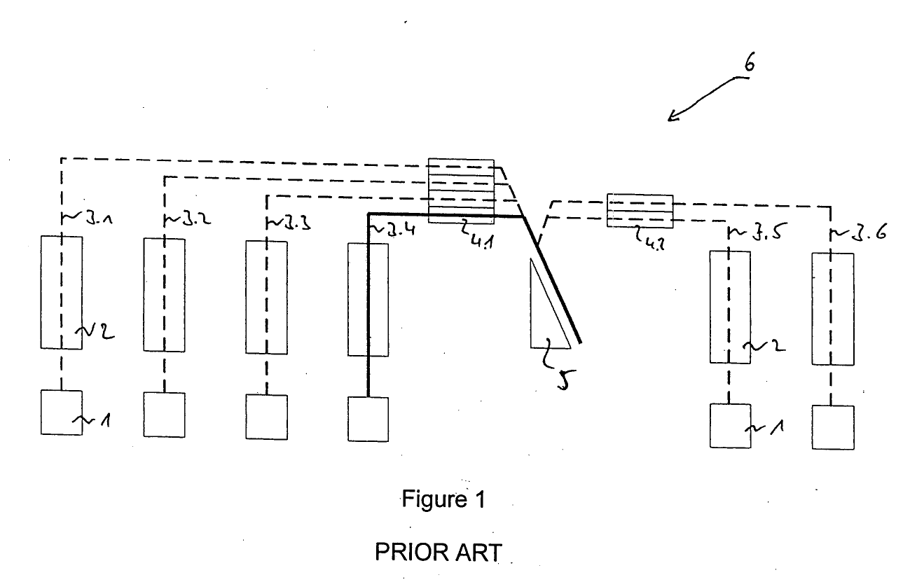

In the following text the present invention will be described in greater detail with reference to FIGS. 1 to 5.

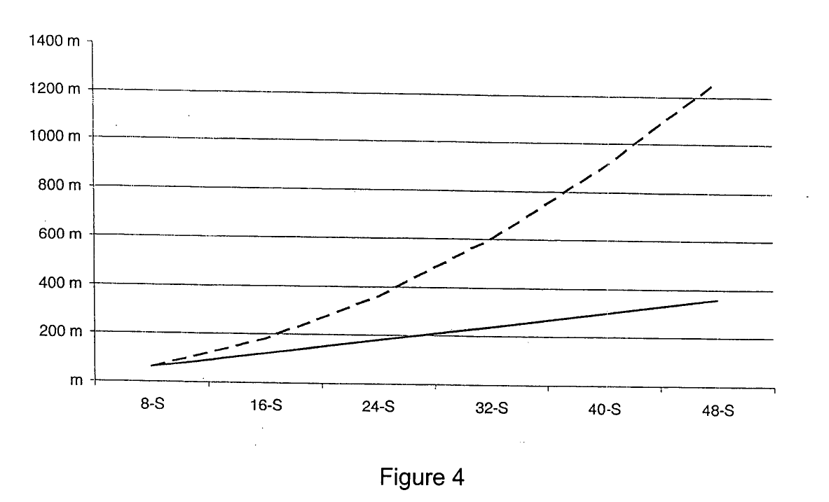

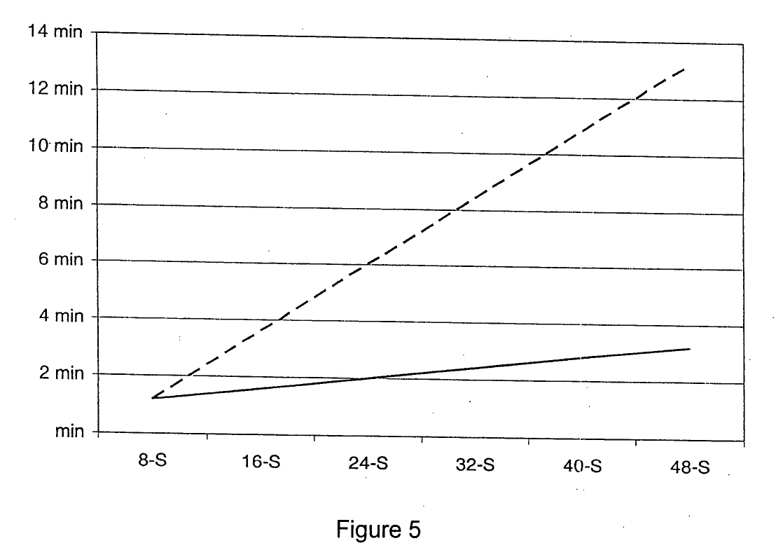

FIG. 1 shows a diagrammatic illustration of the individual insertion of six paper webs 3.1 to 3.6 in a newspaper press 6. Here, all the paper webs 3.1 to 3.6 are inserted from in each case one reel changer 1 via a printing unit 2 to the folder unit 5. The paper webs 3.1 to 3.4 are pulled to the folder unit 5 via the left-hand turner unit 4.1 which has four turner stages. The paper webs 3.5 and 3.6 are pulled to the folder unit 5 via the right-hand turner unit 4.2 which has two turner stages. In the case of individual insertion, as the name already indicates, the paper webs 3.1 to 3.6 are inserted individually one after another. In FIG. 1, the fourth paper web 3.4 is guided to the folder unit 5 as the first paper web, and the other paper webs 3.1-3.3, 3.5 and 3.6 are then in each case pulled to the folder unit 5 individually one after another. This known type of paper supply for preparing for printing is disadvantageous both with regard to the paper wastage and with regard to the duration of the insertion process, depending on the number of paper paths 3.1 to 3.6 used. The paper wastage and the insertion time in the case of individual insertion are explained, inter alia, in the diagrams of FIGS. 4 and 5.

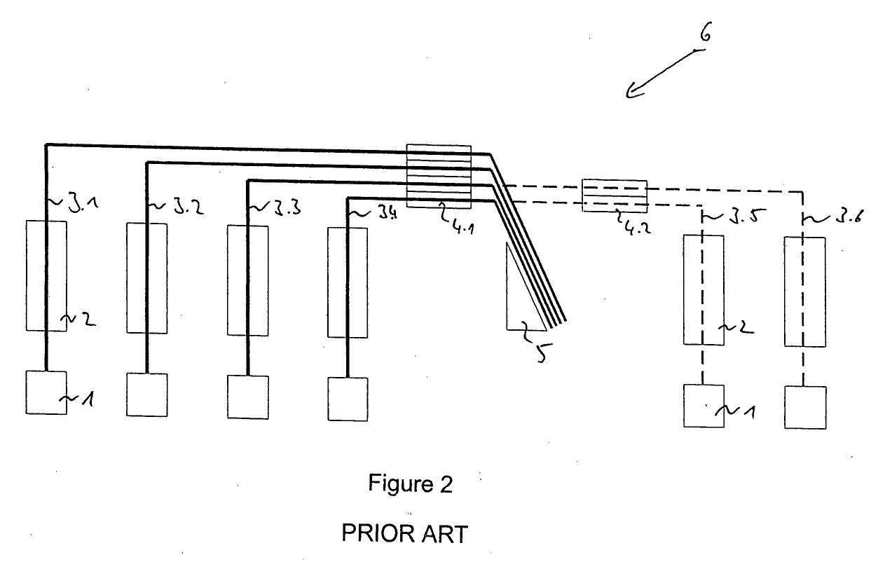

In a diagrammatic illustration, FIG. 2 shows a further possibility for paper insertion in a printing press. In this method of paper insertion, all the paper webs 3.1 to 3.6 are inserted as far as the folder unit 5 simultaneously; this is then called what is known as multiple insertion. Here, possible different web lengths of the different paper webs 3.1 to 3.6 on the different web paths were compensated for by the insertion apparatuses after the reel changers 1 starting up the insertion of paper at different times and then transporting the paper webs at the same speed to the folder unit 5. It proved disadvantageous in this method of paper supply that the paper-inserting tips which lie one above the another and in each case have a material thickness of a few millimeters led to corrugation of the paper webs 3.1 to 3.6 as a result of being layered on top of one another which can then result in tearing of the paper webs or a paper jam in the inlet of the folding former.

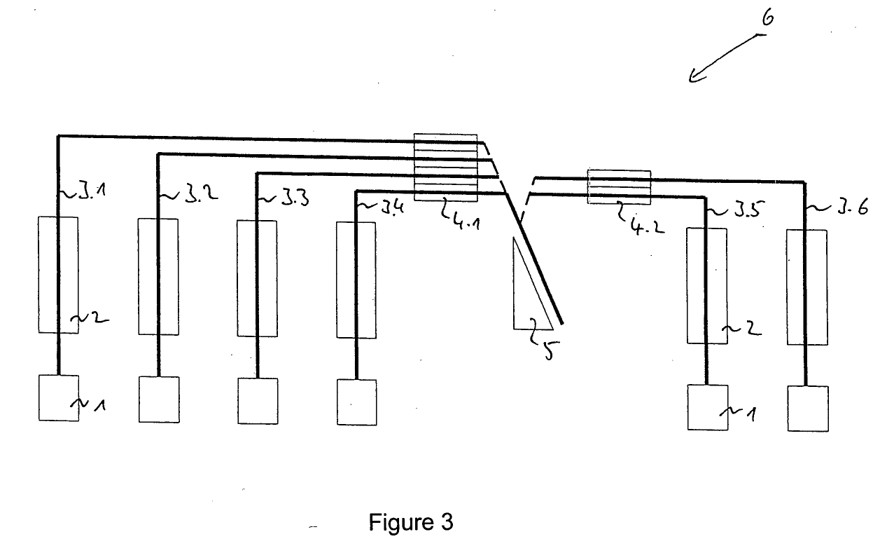

FIG. 3 shows a diagrammatic illustration of the method and apparatus according to the invention during insertion of the paper webs 3.1 to 3.6 in a newspaper press. In the invention, the functional units which belong to a web path, such as reel changers 1 and printing units 2 and their electrical components, are actuated jointly and different functional units of different web paths are controlled individually. As a result, it is possible to run the paper webs on the different web paths, for example, at different speeds, in different rotational directions, or to select different starting and stopping times for the paper webs. As a result of these options, as shown in FIG. 4, all the paper webs 3.1 to 3.6 can be inserted simultaneously to the turner units 4.1 and 4.2, which affords a substantial time advantage over individual insertion. Furthermore, only the paper web 3.4 can be guided initially to the folder unit 5, and the other paper webs 3.1 to 3.3, 3.5 and 3.6 can be guided to the folder unit 5 one after another, which, compared with the multiple insertion method, prevents the paper-inserting tips lying above one another, with the abovementioned disadvantages.

FIG. 4 shows a diagram, in which the theoretically calculated insertion wastage is shown in the case of individual insertion and in the case of magazine insertion of the invention. Here, a newspaper press having path lengths from the reel changer to the folder unit of on average approximately 60 meters has been assumed. Insertion wastage is understood as meaning that amount of paper, quoted in meters, which is unusable and has to be disposed of as waste on account of the paper insertion.

The paper wastage in meters is plotted on the ordinate of the diagram, one part region on the ordinate corresponding to 200 meters of paper. The number of pages of the printed product is plotted on the abscissa, one part region on the abscissa corresponding in each case to an 8-page product. In each case one web path is required in the printing-press system per 8-page product. The paper wastage of the individual insertion operations which follow one another temporally is shown in the diagram as a dashed curve and has an exponential profile, over 1200 meters of paper having been pulled through in the case of a 48-page product. This exponential profile comes from the fact that initially the fourth paper web 3.4 in FIG. 1 (solid line) is inserted as lowermost paper web, and after this the dashed paper webs 3.1-3.3, 3.5 and 3.6 are inserted one after another. While a following paper web is inserted, the paper webs which have already been inserted previously run with it, with the result that the paper wastage is in each case added together exponentially.

The lower solid line in the diagram shows the paper wastage which occurs when the invention is used. This linear curve profile results from the fact that the paper webs 3.1 to 3.6 are inserted as far as the turner units 4.1 and 4.2 uniformly and in parallel. Therefore, approximately 800 meters of paper wastage can be saved by the invention in the case of a 48-page product.

FIG. 5 shows a diagram, in which the theoretically calculated insertion time is shown in the case of individual insertion and in the case of magazine insertion. Here, as in FIG. 4, a newspaper press having 6 web paths which each have an average web length of approximately 60 meters from the reel changer to the folder unit has been assumed. The insertion time is that amount of time, after which all the paper webs have been inserted to the extent that printing can be started.

The insertion time is plotted on the ordinate of the diagram in minutes, a part region on the ordinate corresponding to 2 minutes. In an analogous manner to the diagram from FIG. 4, the number of pages of the printed product is plotted on the abscissa.

Both the insertion time of the individual insertion and of the magazine insertion have a linear profile. As, however, the paper webs are inserted on the individual paths in parallel next to one another with the invention, the insertion time is generally shorter. The solid curve therefore has a smaller gradient overall in the diagram. In the case of an 8-page product, in which only one paper web or one web path is used, the insertion time is identical in the case of individual insertion and in the case of magazine insertion. In the case of a 48-page product, the invention can achieve a time saving of approximately 10 minutes for the insertion of all 6 paper webs.

Overall, the invention makes it possible for the changeover time of the printing-press system to be reduced and for the utilization and the production efficiency to be increased.

### LIST OF REFERENCE NUMERALS

1 Reel changer

2 Printing unit

3.1 First paper web/first web path

3.2 Second paper web/second web path

3.3 Third paper web/third web path

3.4 Fourth paper web/fourth web path

3.5 Fifth paper web/fifth web path

3.6 Sixth paper web/sixth web path

4.1 Left-hand turner unit

4.2 Right-hand turner unit

5 Folder unit

6 Printing-press system

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a printing-press system, in which at least one paper web is guided, printed and folded by functional units of the printing press on at least one web path for a printing process, the functional units having at least one paper-inserting means, at least one reel changer, at least one printing unit and at least one folder apparatus, wherein the functional units which belong to a web path are actuated jointly and different functional units of different web paths are controlled individually.

2. The method according to claim 1, wherein the functional units of the different web paths are operated at different speeds.

3. The method according to claim 1, wherein the functional units of the different web paths are operated in different rotational directions.

4. The method according to claim 1, wherein the functional units of the different web paths are started at different times.

5. The method according to claim 1, wherein the functional units of the different web paths are stopped at different times.

6. The method according to claim 1, wherein drives which belong to a specific web path are actuated jointly.

7. The method according to claim 1, wherein the printing units have at least one plate cylinder and one blanket cylinder which are cleaned by a cleaning apparatus, wherein cleaning processes are started and stopped individually in the different printing units.

8. A method for operating a printing-press system, comprising the steps of:
controlling an operation of first functional units of a first web path in the printing-press system; and
controlling an operation of second functional units of a second web path in the printing-press system;
wherein the operation of the first functional units of the first web path is controlled independently of the operation of the second functional units of the second web path.

9. The method according to claim 8, wherein the functional units of the first and second web paths each include a paper-inserting mechanism, a reel changer, a printing unit, and a folder apparatus.

10. The method according to claim 8, wherein the step of controlling the operation of the first functional units of the first web path includes operating the first functional units at a first speed and wherein the step of controlling the operation of the second functional units of the second web path includes operating the second functional units at a second speed.

11. The method according to claim 8, wherein the step of controlling the operation of the first functional units of the first web path includes operating the first functional units in a first rotational direction and wherein the step of controlling the operation of the second functional units of the second web path includes operating the second functional units in a second rotational direction.

12. The method according to claim 8, wherein the step of controlling the operation of the first functional units of the first web path includes starting the first functional units at a first start time and wherein the step of controlling the operation of the second functional units of the second web path includes starting the second functional units at a second start time.

13. The method according to claim 8, wherein the step of controlling the operation of the first functional units of the first web path includes stopping the first functional units at a first stop time and wherein the step of controlling the operation of the second functional units of the second web path includes stopping the second functional units at a second stop time.

14. An apparatus for controlling the operation of a printing-press system, comprising:
a first web path in the printing-press system including first functional units;
a second web path in the printing-press system including second functional units; and
a controller coupled to the first and second functional units, wherein the controller controls an operation of the first functional units of the first web path and an operation of the second functional units of the second web path, and wherein the operation of the first functional units is controlled independently of the operation of the second functional units.

15. The apparatus according to claim 14, wherein the functional units of the first and second web paths each include a paper-inserting mechanism, a reel changer, a printing unit, and a folder apparatus.

16. The apparatus according to claim 14, wherein the controller controls the operation of the first functional units of the first web path such that the first functional units operate at a first speed and controls the operation of the second functional units of the second web path such that the second functional units operate at a second speed.

17. The apparatus according to claim 14, wherein the controller controls the operation of the first functional units of the first web path such that the first functional units rotate in a first rotational direction and controls the operation of the second functional units of the second web path such that the second functional units rotate in a second rotational direction.

18. The apparatus according to claim 14, wherein the controller controls the operation of the first functional units of the first web path such that the first functional units start at a first start time and controls the operation of the second functional units of the second web path such that the second functional units start at a second start time.

19. The apparatus according to claim 14, wherein the controller controls the operation of the first functional units of the first web path such that the first functional units stop at a first stop time and controls the operation of the second functional units of the second web path such that the second functional units stop at a second stop time.

20. The apparatus according to claim 14, wherein a first paper web in the first web path is inserted simultaneously into a turner unit with a second paper web in the second web path and wherein the first paper web in the first web path is guided to a folder unit before the second paper web in the second web path is guided to the folder unit.
